(19) United States
(12) Patent Application Publication
(10) Pub. No.: US 2006/0210826 A1
(43) Pub. Date: Sep. 21, 2006

(54) Co-based wire and method for saw tip manufacture and repair

(76) Inventors: James B. C. Wu, St. Louis, MO (US); Heidi L. de Villiers-Lovelock, Swindon (GB)

Correspondence Address: SENNIGER POWERS, ONE METROPOLITAN SQUARE, 16TH FLOOR, ST LOUIS, MO, 63102, US

(21) Appl. No.: 11/085,308

(22) Filed: Mar. 21, 2005

(51) Int. Cl. B32B 19/00

(52) U.S. Cl. 428/689; 428/408

(57) ABSTRACT

A Co-based alloy, a tubular wire with a Co-based sheath, and a method for forming a saw tip involving an alloy comprising, by approximate weight %, C (0.3-2.4), B (0.1-1.0), Cr (25-35), Mo (4-20), Si (0.1-1.57), Co (Balance), wherein the total concentration of boron and carbon is between about 1.2 wt % and about 2.5 wt % and the Si has a concentration no greater than about (1.8−(0.12[Mo])+(0.1*([B]+[C]))).

### FIELD OF THE INVENTION

The present invention relates generally to a Co-based alloy. More particularly, the invention relates to a Co-based wire and method for use in the manufacture and repair of saw cutting tips.

### BACKGROUND OF THE INVENTION

Saw blades deteriorate at the cutting tips at a high rate, especially in the case of high speed saws. When saw tips become dull, cutting efficiency is greatly reduced. Typically, blades are sharpened or “re-tipped” by the user.

Commonly used saw tip materials include tungsten carbide composites, usually in a Co matrix, and Co—Cr—W alloys. Typically, the alloys are formed into a saw tip or tooth and attached to the saw blade by brazing or welding. Brazing is often used to attach tungsten carbide composites with cadmium-containing brazing alloys, which are considered to be hazardous because of their cadmium content. Furthermore, the strength of the brazing material is often inadequate, such that the tips break off at the bond.

Welding is another way to join or form saw tooth tips. Specific welding techniques vary widely and can be broadly categorized as, e.g., arc welding, resistance welding, oxyfuel gas welding, and electron or laser beam welding techniques. Within the category of arc welding techniques, there is a variety of welding processes. For example, metal inert gas (MIG) welding, flux-cored arc welding, submerged-arc welding, tungsten inert gas (TIG) welding, and plasma-transferred-arc (PTA) welding are a few arc welding techniques. In each, an electric arc formed between two electrodes serves as the heat source to fuse the metal or melt the metal filler. In some techniques, the base material serves as one of the electrodes (e.g., TIG), while in others, both of the electrodes are within the heat source (e.g., plasma-arc welding). Compared to brazing, electric resistance welding or gas-tungsten-arc welding is often used to attach Co—Cr—W alloys onto saws, yielding a stronger metallurgical bond.

In addition to using welding techniques to join a separate tip to the saw blade, saw tooth tips can be formed by weld buildup. Using this technique, metal is melted to form the weld pool and allowed to cool in the final desired shape of a saw tooth. Here, the weld metal actually forms the saw tooth on the saw blade, rather than joining a separate tip to the saw blade. Also, the saw blade acts as an electrode during the weld buildup. This technique is problematic when applying an alloy comprising Co because of Co's high melting point. The high melting point requires higher applied current to produce a melt pool on the saw blade. Further, the area of the saw blade on which the tip is built up is relatively small, restricting the amount of current that can be applied without damaging or melting the saw blade substrate. Industry practice is to use solid Co-based wires that are drawn or extruded, which represent a significant expense.

U.S. Pat. No. 6,479,014 discloses Co—Cr—Mo and Co—Cr—Mo—W alloys for saw tips.

### SUMMARY OF THE INVENTION

Among the objects of the invention, therefore, is the provision of a Co-based wire that can be used during a weld buildup operation and be produced economically.

Briefly, therefore, the invention is directed to a Co-based saw tip for a saw blade and a method of the deposition thereof on a saw blade. The tip comprises, by approximate wt %, 0.3-2.4% C, 0.1-1.0% B, 25-35% Cr, 4-20% Mo, 0.1-1.57% Si, and the balance Co. The alloy's total concentration of boron and carbon is between about 1.2 wt % and about 2.5 wt %, and the Si has a concentration no greater than about (1.8−(0.12*[Mo])+(0.1*([B]+[C]))).

The invention is further directed to a Co-based saw tip alloy for the formation of a saw tip on a saw blade, the alloy comprising, by approximate wt %, 0.3-2.4% C, 0.1-1.0% B, 25-35% Cr, 4-20% Mo, 0.1-1.57% Si, and the balance Co. The alloy's total concentration of boron and carbon is between about 1.2 wt % and about 2.5 wt %, and the Si has a concentration no greater than about (1.8−(0.12*[Mo])+(0.1*([B]+[C]))).

The invention is still further directed to a tubular wire for the formation of a saw tip on a saw blade, the tubular wire comprising metal powder of the elements C, B, Cr, Mo, and Si within a Co-based sheath in proportions which provide an alloy comprising the following constituents by weight upon melting of the tubular wire, by approximate weight percent, 0.3-2.4% C, 0.1-1.0% B, 25-35% Cr, 4-20% Mo, 0.1-1.57% Si, and the balance Co. The alloy's total concentration of boron and carbon is between about 1.2 wt % and about 2.5 wt %, and the Si has a concentration no greater than about (1.8−(0.12*[Mo])+(0.1*([B]+[C]))).

Other objects and features of this invention will be in part apparent and in part pointed out hereinafter.

### BRIEF DESCRIPTION OF THE DRAWINGS

FIG. 1 is a schematic of a mold used for forming a saw tooth tip.

FIG. 2 is a schematic showing the two plates of the saw tooth tip mold.

FIG. 3 is a schematic of a saw blade substrate being fitted into the saw tooth tip mold to leave a saw tooth mold cavity.

FIG. 4 is a schematic of a saw blade substrate having a saw tooth tip formed thereon after removal from the mold.

FIG. 5 is a photograph of a saw blade substrate fitted into one plate of the mold to leave a saw tooth mold cavity.

FIG. 6 is a photograph of a saw blade substrate having a saw tooth tip formed thereon after removal from the mold.

FIG. 7 is a photograph of a hand ground saw blade and tip.

FIG. 8 is a 500× photomicrograph of a saw tip alloy's microstructure.

FIG. 9 is a 1000× photomicrograph of a saw tip alloy's microstructure.

FIG. 10 is a 2000× photomicrograph of a saw tip alloy's microstructure.

FIG. 11 is an 800× photomicrograph of a saw tip alloy's microstructure where all the raw materials were completely molten prior to formation.

### DETAILED DESCRIPTION OF THE PREFERRED EMBODIMENTS

In accordance with this invention, a Co-based alloy is deposited on a saw blade's substrate to form a saw tooth or tip for cutting. In one embodiment, this is accomplished via weld buildup. In this embodiment, any welding technique suitable for use in a weld buildup application can be used. For example, MIG welding, flux-cored arc welding, submerged-arc welding, TIG welding, and PTA welding can be used to apply a weld buildup.

In one embodiment, TIG welding is employed to heat a filler metal to its melting point. TIG welding is also known as gas tungsten arc welding (GTAW). Here, heat is generated by an arc formed between the work metal and a non-consumable tungsten electrode. This heat produces coalescence of the filler metal and between the filler metal and the substrate. A gas is used for shielding the molten weld metal. Using tungsten electrodes is preferred because of tungsten's high melting temperature and because it is a strong emitter of electrons.

In one preferred embodiment, PTAW is employed to heat a filler metal to its melting point. Plasma-transferred-arc welding is similar to TIG welding, but a nozzle is used to constrict the arc in PTAW, thereby increasing the arc temperature and further concentrating the heat pattern.

Regardless of the specific welding technique employed, the filler metal in accordance with the invention is a Co-based alloy. Cobalt is the preferred base metal for the weld buildup because Co-based alloys display resistance to heat, abrasion, corrosion, galling, oxidation, thermal shock, and wear, which have desirable properties for saw tips. Further, Co alloys well with several desirable alloying elements and tends to form a tough matrix. Stated otherwise, Co is a preferred base metal for the saw tip alloy because it provides superior performance under typical saw operating conditions.

The invention is, therefore, in one aspect a Co-based filler metal composition for an arc welding process for building up saw tips. This filler metal composition, in a preferred form, comprises the following, by approximate weight %:

| | |
|---|---|
| C | 0.3-2.4 |
| B | 0.1-1.0 |
| Cr | 25-35 |
| Mo | 4-20 |
| Si | 0-1.57 |
| Mn, Ni, plus Fe | 0-10 |
| W | 0-4 |
| Co | Balance; |

wherein the total concentration of boron and carbon is between about 1.2 wt % and about 2.5 wt %; and wherein the maximum Si concentration is calculated according to the following formula:
(1.8−(0.12*[Mo])+(0.1*([B]+[C])))=Si wt % max.

According to this invention, C is employed in the filler metal to improve the final alloy's wear resistance. This is accomplished by reacting with other alloying elements to form hard carbides, such as Mo carbides. In one embodiment, the concentration of C in the filler metal is between about 0.3 wt % and about 2.4 wt %. For example, the C has a concentration between about 0.5 wt % and about 2.4 wt %. In one such embodiment, the C has a concentration between about 0.5 wt % and about 1.9 wt %. In one preferred embodiment, the C concentration is about 1.2 wt %.

Boron is incorporated in the filler metal to lower the filler metal's melting temperature. By doing so, B advantageously assists in completely melting the Co-based filler metal. Further, the lower melting point corresponds to lower requirements for applied current to melt the filler metal. Pure Co has a melting point around 1495° C. The addition of B as an alloying element in the Co-based alloys described herein lowers the filler metal alloy's liquidus melting point to between 1150° C. and 1280° C., depending on the concentration of B and other elements to a lesser degree. This is critical to achieving the goal of the invention to provide an alloy attachable as a saw tooth where current input is severely restricted by the small size of the attachment zone. In one embodiment, the concentration of B in the filler metal is between about 0.1 wt % and about 1 wt %. For example, the B has a concentration between about 0.1 wt % and about 0.6 wt %. In one such embodiment, the B has a concentration between about 0.3 wt % and about 0.6 wt %. In one preferred embodiment, the B concentration is about 0.44 wt %.

The combined concentration of C and B in the filler metal is carefully controlled between about 1.2 wt % and about 2.5 wt %. It has been determined that if the combined concentration of C and B is less than about 1.2 wt %, the final alloy's wear resistance is not adequate for saw tip applications. Also, if the combined concentration of C and B is greater than about 2.5 wt %, the final alloy becomes too brittle for saw tipping purposes. Accordingly, this is an independent requirement of certain embodiments of the invention. That is, this requirement must be satisfied in addition to the separate requirements for C and B described in the preceding paragraphs.

Chromium is provided in the filler metal of the invention to enhance the final alloy's corrosion resistance. In one embodiment, the concentration of Cr in the filler metal is between about 25 wt % and about 35 wt %. For example, the concentration of Cr is between about 28 wt % and about 33 wt %. In one such embodiment, the concentration of Cr is between about 31 wt % and about 33 wt %. In one preferred embodiment, the concentration of Cr is about 32 wt %.

Molybdenum is employed in the filler metal to enhance abrasion and corrosion resistance. Though prior art alloys rely heavily on W for this function, Mo atoms are much smaller than W atoms, and with an atomic weight roughly half the atomic weight of W, there are roughly twice as many Mo atoms for a given weight percentage. Molybdenum has a greater affinity for C than does W, and diffuses much more quickly due to its smaller size, thereby favoring the formation of carbides to impart abrasion resistance. Furthermore, Mo imparts greater corrosion resistance than does W in acidic environments of a reducing nature, which are often encountered in wood cutting applications. While the corrosion resistance imparted by Mo is believed to be imparted by Mo in solid solution, the wear resistance is imparted primarily by the formation of Mo carbides. In one embodiment, the concentration of Mo in the filler metal is between about 4 wt % and about 20 wt %. For example, the concentration of Mo is between about 5 wt % and about 15 wt %. In one such embodiment, the concentration of Mo is between about 7.5 wt % and about 9.5 wt %. In one preferred embodiment, the concentration of Mo is about 8.5 wt %.

Silicon may be incorporated in the filler metal alloy to facilitate melting and act as a deoxidizer. The concentration of Si should be high enough such that these advantageous affects are realized in the alloy, but low enough such that brittle silicides do not form. For instance, if the Si concentration is too high, Si may combine with Mo to form brittle molybdenum silicides. In one embodiment, the Si concentration in the final filler metal alloy is between about 0 wt % and about 1.57 wt %, for example, between about 0.1 wt % and about 1.57 wt %. In one preferred embodiment, the concentration of Si is between about 0.1 wt % to about 1.4 wt %, and even more preferably between about 0.4 wt % to about 1.4 wt %. In each embodiment according to the invention, the maximum Si concentration is a function of the Mo, B, and C concentrations. Specifically, the maximum Si concentration is calculated according to the following formula:
(1.8−(0.12*[Mo])+(0.1*([B]+[C])))=Si wt % max

Silicon concentration is a function of Mo because of the aforementioned brittle silicides that can form. Silicon concentration is also dependent on B and C because these two elements tend to prevent the formation of Mo silicides by tying up Mo. As such, their addition increases the tolerance for Si in the alloy.

Other elements such as Mn, Ni, and Fe may be present as incidental impurities, or as intentional additions to improve melting characteristics. In particular, up to about 10 wt %, preferably up to about 8 wt %, of these elements cumulatively are included in the alloy.

Tungsten may optionally be included in the filler metal to improve the final alloy's wear resistance. In one embodiment, however, W is completely omitted. Therefore, the concentration of W in the filler metal is between about 0 wt % and about 4 wt %. For example, the concentration of W is between about 1 wt % and about 4 wt %. In one such embodiment, the concentration of W is between about 1 wt % and about 2.5 wt %. In one preferred embodiment, the concentration of W is about 1.3 wt %.

The filler material is prepared in a form to facilitate forming saw tips on saw blades. For example, the filler material may be prepared as powder metallurgy preforms in the shape of saw tips, as powder metallurgy pre-shaped rods for tipping saw blades, as cast rods for welding onto saw blades, or as solid or tubular wires for welding onto saw blades.

In one preferred embodiment, in order to deliver the foregoing filler metal composition to the substrate, the inventors have developed a preferred mechanism of a Co-based sheath with alloying constituents in the form of metal powder or particulates therein. In one such embodiment, the Co-based sheath is at least about 94 wt % Co, with the remainder being essentially Ni and/or Fe. Other alloying elements, such as C, B, Cr, Mo, and perhaps additional Co, are in powder form that is held within the sheath. The powder alloying elements are present in a proportion such that, when coalesced with the Co-based sheath during melting and build up onto a saw blade, an overall filler metal composition as described above is attained.

The Co-based sheath is engineered to have a wall thickness and diameter such that it is readily extrudable and provides an interior volume of the correct size to hold a volume of powder which, when all are coalesced, yields the desired final filler metal composition. The final filler metal composition is controlled by delivering the required amount of powder of calculated chemistry, in light of the thickness and chemistry of the sheath, onto the sheath after the sheath has been formed into a “U” shape. The sheath is subsequently formed into a tube having the powder therein to form the tubular wire.

After the tubular wire comprising the Co-based metal sheath and the desired powder alloying elements therein has been formed, the tubular wire can be used in one of the previously noted welding techniques. In general, heat sufficient to melt the tubular wire is generated to form a weld pool on the saw blade substrate where the final saw tooth will be formed. The weld pool comprises the molten tubular wire—both the sheath and powder therein—as well as some molten substrate material. Typically, for example, the substrate may be a tool steel or a medium C steel. In an embodiment utilizing weld buildup, the arc and filler material are then maneuvered such that the weld pool solidifies in the final form of a saw tooth. In one of these embodiments, a tooth-shaped mold is used to help form the saw tooth appropriately. The process of the invention may be used for initially forming saw tooth tips on a saw blade or to repair saw blades with tips that have been damaged or have broken off.

Further illustration of the invention is provided by the following working examples.

### EXAMPLE 1

### Forming of Tubular Wire

A Co-based tubular wire was prepared for saw tooth build-up to provide a filler metal composition, i.e., a saw tooth composition, as follows:

| | |
|---|---|
| C | 1.4 wt % |
| Cr | 29 wt % |
| Mo | 8.5 wt % |
| W | 0.1 wt % |
| Si | 0.8 wt % |
| B | 0.5 wt % |
| Ni | 1.4 wt % |
| Fe | 1.6 wt % |
| Co | Balance |

This was accomplished by using a continuous, flat strip of a cobalt-based alloy approximately comprising: 95 wt % Co, <0.5 wt % Ni, and 5.0 wt % Fe. The strip was about 0.23 mm thick and about 7 mm wide. The strip was fed through a wire fabrication machine and formed into a “U” shape by a set of roller dies. A powder mixture containing calculated amounts of C, Cr, Mo, W, Si, and B was fed onto the moving U-shaped strip, which was then formed into a “6” shape and finally into an “0” shape by sets of roller dies. The wire then had about a 2.4 mm diameter, which was further reduced to 2.0 mm in diameter by drawing and sizing through a series of forming rolls. The powder mixture had a composition of 3.2 wt % C, 66 wt % Cr, 19 wt % Mo, 5.5 wt % Ni, 2.0 wt % Si, and 1.2 wt % B such that, upon coalescence with and dilution by the Co-based sheath, a filler metal with the composition noted at the beginning of the Example was produced.

### EXAMPLE 2

### Forming Saw Tooth Via Weld Build-Up

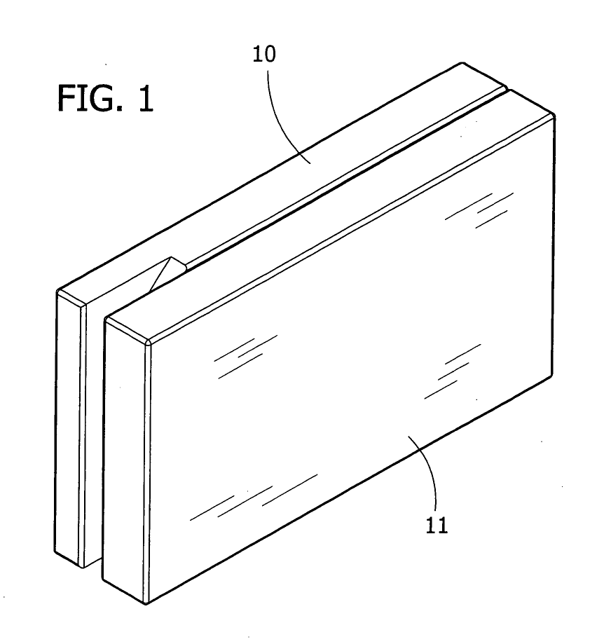

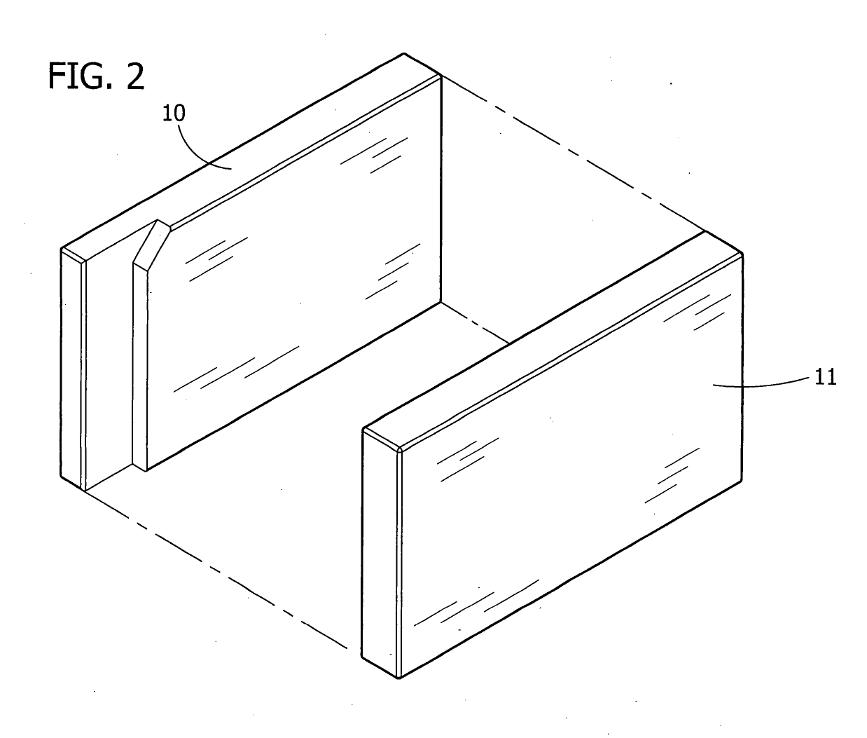

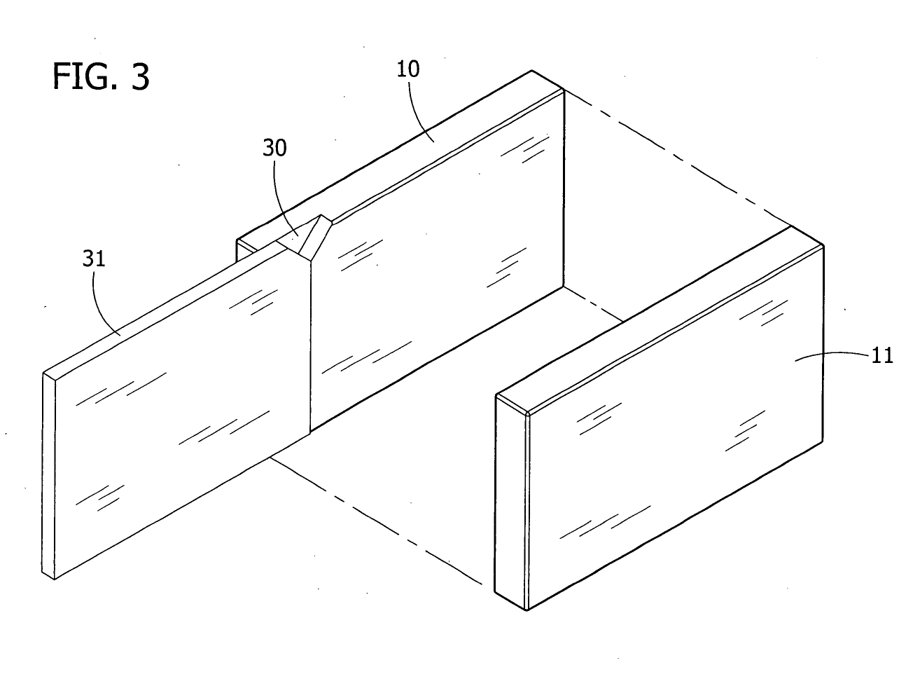

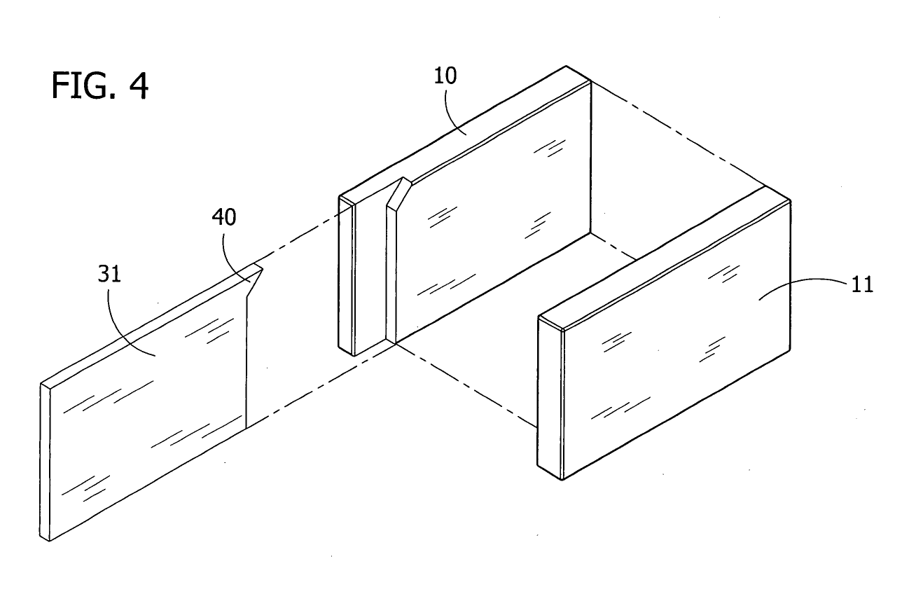

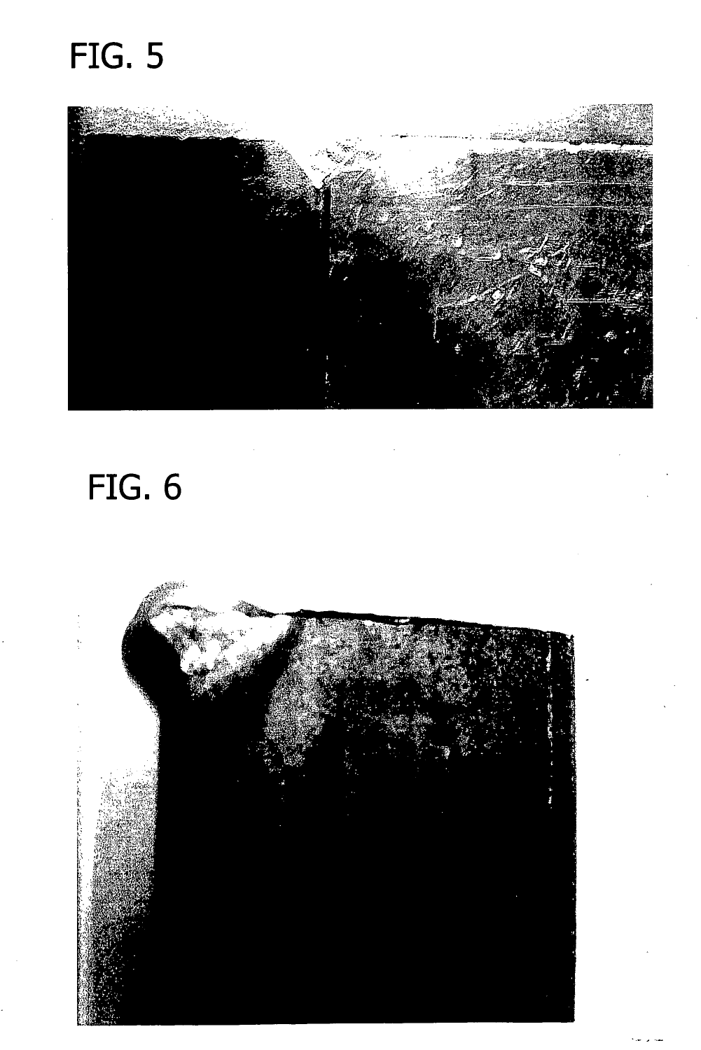

The tubular wire from EXAMPLE 1 was used in a GTAW application to form a saw tooth on a saw blade substrate. With reference to FIG. 1-4, the saw blade was a medium carbon steel, which was clamped between two copper plates 10 and 11 to form a copper mold having a mold cavity 30. Heat was generated by an arc formed between the tungsten electrode and the substrate 31. The tubular wire was brought near the arc to sufficiently coalesce the Co-based sheath and the powder alloying elements and form a weld pool on the saw blade substrate 31 where the saw tooth was formed. The weld pool comprised the molten tubular wire and some molten substrate material. The electrode and the tubular wire were maneuvered such that the weld pool solidified in the final form of a saw tooth tip 40 in the mold cavity 30. The cavity 30 was in the shape of a 45-degree triangle with sides of 10 mm in length and a depth of 3 mm to form a saw tooth tip 40 of approximately the same dimensions. One half of the cavity was formed by the copper mold 10 and the other half by the 3 mm-wide steel plate 31, as shown in FIGS. 3 and 5.

The following welding parameters were used:

| Current | 19-20 | A |
|---|---|---|
| Voltage | 110-120 | V |
| Electrode diameter | 3.2 | mm |
| Gas cup diameter | 19 | mm |
| Shielding gas flow | 12 | L/min. |
| Shielding gas type | Argon 99.99% | |
| Wire diameter | 2.0 | mm nominal |

| | |
|---|---|
| Wire type | Cored (bare) |

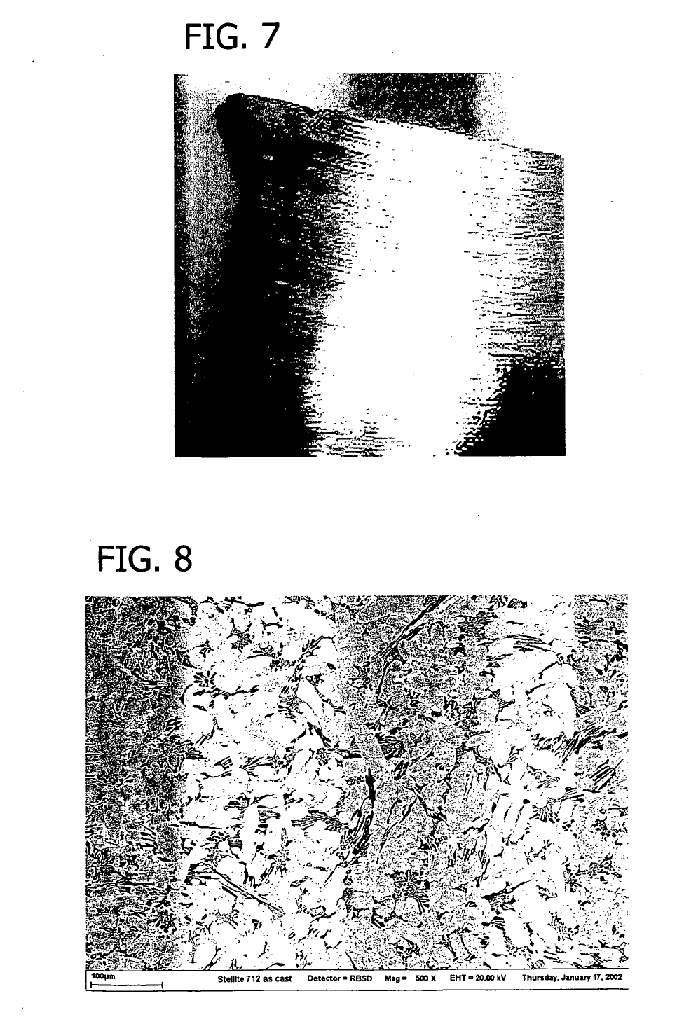

An as-welded formed saw tooth is shown in FIG. 6. The saw tooth 40 was then ground to form the final sharp edge. This process can be down automatically, but the tooth was hand ground here into the final shape of the saw tooth shown in FIG. 7.

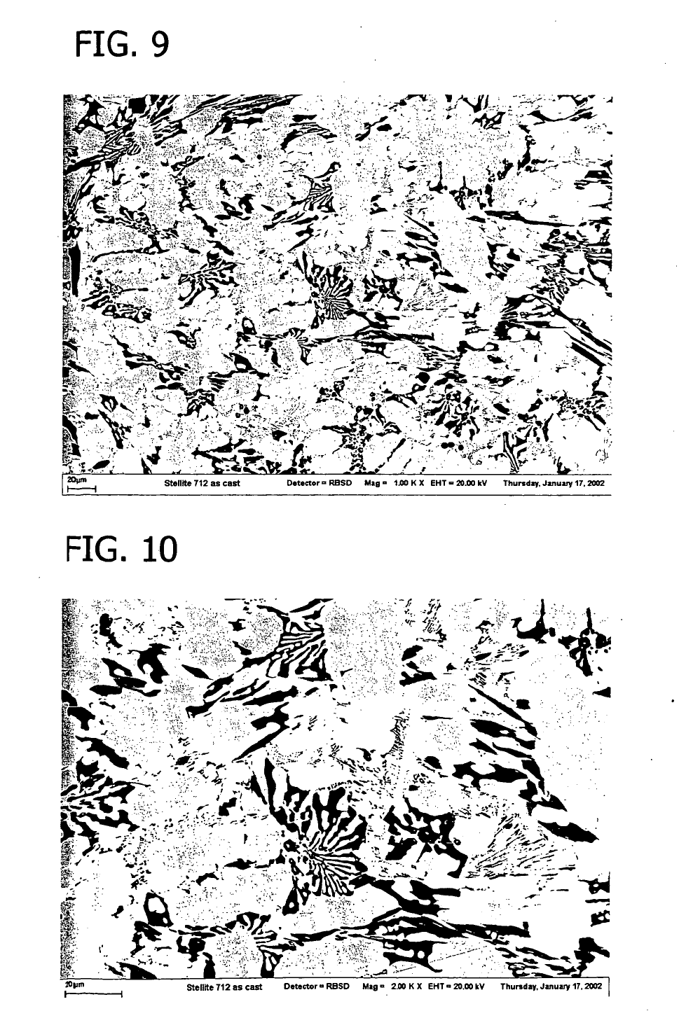

The microstructure of the saw tooth's alloy is shown at 500×, 100×, and 2000× in FIGS. 8-10, respectively. In each Figure, the white phases represent Mo-rich carbides, the solid light grey areas are the CoCr solid solution alloy matrix, and the very dark areas are the Cr-rich carbides.

### EXAMPLE 3

### Microstructure of Alloy

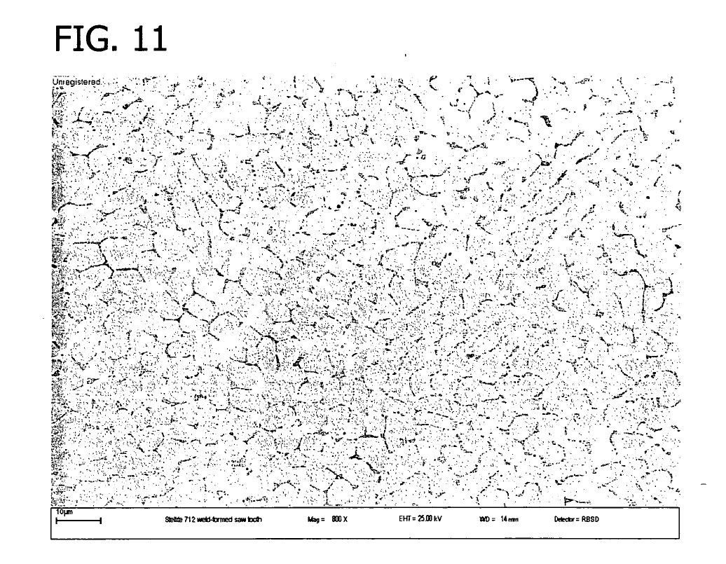

For comparison with the microstructure of the saw tooth obtained from Example 2, an alloy was formed wherein all of the raw materials, e.g. the Co-based tube and alloying powders, were completely melted prior to solidification. The microstructure of the alloy is shown in FIG. 11. This microstructure shows greater uniformity in grain size and shape, as well as distinct separation between the Cr- and Mo-rich regions.

When introducing elements of the present invention or the preferred embodiment(s) thereof, the articles “a,” “an,” “the,” and “said” are intended to mean that there are one or more of the elements. The terms “comprising,” “including,” and “having” are intended to be inclusive and mean that there may be additional elements other than the listed elements.

In view of the above, it will be seen that the several objects of the invention are achieved and other advantageous results attained.

As various changes could be made in the above methods and products without departing from the scope of the invention, it is intended that all matter contained in the above description and shown in the accompanying drawings shall be interpreted as illustrative and not in a limiting sense.

What is claimed is:

1. A Co-based saw tip alloy for the formation of a saw tip on a saw blade, the alloy comprising, by approximate wt %:

| | |
|---|---|
| C | 0.3-2.4 |
| B | 0.1-1.0 |
| Cr | 25-35 |
| Mo | 4-20 |
| Si | 0-1.57 |
| Co | Balance; |

wherein the total concentration of boron and carbon is between about 1.2 wt % and about 2.5 wt %;
wherein the Si has a concentration no greater than about (1.8−(0.12*[Mo])+(0.1*([B]+[C]))).

2. The Co-based saw tip alloy of claim 1 wherein the alloy is prepared in a form selected from the group of forms consisting of powder metallurgy preforms in the shape of saw tips, powder metallurgy pre-shaped rods for tipping saw blades, cast rods for welding onto saw blades, and wires for welding onto saw blades.

3. The Co-based saw tip alloy of claim 1 consisting essentially of, by approximate weight %:

| | |
|---|---|
| C | 0.3-2.4 |
| B | 0.1-1.0 |
| Cr | 25-35 |
| Mo | 4-20 |
| Si | 0.1-1.57 |
| Mn + Ni + Fe | 0-10 |
| W | 1-4 |
| Co | Balance. |

4. The Co-based saw tip alloy of claim 1 wherein the Si has a concentration between about 0.1 wt % and about 1.4 wt %.

5. The Co-based saw tip alloy of claim 1, wherein the alloy is used for the formation of saw tips on saw blades for cutting wood, the alloy consisting essentially of about 1.2 wt % C, about 0.5 wt % B, about 29 wt % Cr, about 8.5 wt % Mo, from about 0 to about 10 wt % elements selected from the group consisting of Mn, Ni, and Fe, between about 0.1 and about 1.4 wt % Si, and the balance being Co.

6. A tubular wire for the formation of a saw tip on a saw blade, the tubular wire comprising metal powder of the elements C, B, Cr, Mo, and Si within a Co-based sheath in proportions which provide an alloy comprising the following constituents by weight upon melting of the tubular wire, by approximate weight %:

| | |
|---|---|
| C | 0.3-2.4 |
| B | 0.1-1.0 |
| Cr | 25-35 |
| Mo | 4-20 |
| Si | 0.1-1.57 |
| Co | Balance; |

wherein the total concentration of boron and carbon is between about 1.2 wt % and about 2.5 wt %;
wherein the Si has a concentration no greater than about (1.8−(0.12*[Mo])+(0.1*([B]+[C]))).

7. The tubular wire of claim 6 consisting essentially of, by approximate weight %:

| | |
|---|---|
| C | 0.3-2.4 |
| B | 0.1-1.0 |
| Cr | 25-35 |
| Mo | 4-20 |
| Si | 0.1-1.57 |
| Mn + Ni + Fe | 0-10 |
| W | 1-4 |
| Co | Balance. |

8. The tubular wire of claim 6, wherein the outer diameter of the wire is between about 0.8 mm and about 4 mm.

9. The tubular wire of claim 6 wherein the Si has a concentration between about 0.1 wt % and about 1.4 wt %.

10. The tubular wire of claim 6, wherein the tubular wire is used in the formation of saw tips on saw blades for cutting wood, the tubular wire consisting essentially of:
a Co-based sheath comprising about 95 wt % Co, 2.5 wt % Ni and 2.5% Fe; and
metal powder within the sheath, the metal powder consisting essentially of the elements C, B, Cr, Mo, Mn, and Si in proportions that provide an alloy comprising the following constituents upon melting of the tubular wire:
about 1.2 wt % C, about 0.5 wt % B, about 32 wt % Cr, about 1.3 wt % W, about 18 wt % Mo, from about 0 to about 10 wt % elements selected from the group consisting of Mn, Ni, and Fe, between about 0.1 and about 1.4 wt % Si, and the balance being Co.

11. A Co-based saw tip for a saw blade, the saw tip comprising, by approximate weight %:

| | |
|---|---|
| C | 0.3-2.4 |
| B | 0.1-1.0 |
| Cr | 25-35 |
| Mo | 4-20 |
| Si | 0.1-1.57 |
| Co | Balance; |

wherein the total concentration of boron and carbon is between about 1.2 wt % and about 2.5 wt %;
wherein the Si has a concentration no greater than about (1.8−(0.12*[Mo])+(0.1*([B]+[C]))).

12. The Co-based saw tip of claim 11 consisting essentially of, by approximate weight %:

| | |
|---|---|
| C | 0.3-2.4 |
| B | 0.1-1.0 |
| Cr | 25-35 |
| Mo | 4-20 |
| Si | 0.1-1.57 |
| Mn + Ni + Fe | 0-10 |
| W | 1-4 |
| Co | Balance. |

13. The Co-based saw tip of claim 11 wherein the Si has a concentration between about 0.1 wt % and about 1.4 wt %.

14. The Co-based saw tip of claim 11 consisting essentially of about 32 wt % Cr, about 8.5 wt % Mo, 0 wt % W, from about 0.3 to about 2.4 wt % C, from about 0.1 to about 1.0 wt % B, from about 0 to about 10 wt % elements selected from the group consisting of Mn, Ni, and Fe, between about 0.1 and about 1.4 wt % Si, and the balance being Co;
wherein the total concentration of boron and carbon is between about 1.2 wt % and about 2.5 wt %; and
wherein the maximum Si concentration is calculated to be less than about (1.8−(0.12*[Mo])+(0.1*([B]+[C]))).

15. The Co-based saw tip of claim 11 consisting essentially of about 29 wt % Cr, about 8.5 wt % Mo, 1.3 wt % W, about 1.3 wt % C, about 0.5 wt % B, from about 0 to about 10 wt % elements selected from the group consisting of Mn, Ni, and Fe, about 0.8 wt % Si, and the balance being Co.

16. A method of applying a saw tip to a saw blade comprising:
melting a filler metal to form a weld pool that solidifies as the saw tip on the saw blade;
wherein the filler metal comprises by approximate weight %:

| | |
|---|---|
| C | 0.3-2.4 |
| B | 0.1-1.0 |
| Cr | 25-35 |
| Mo | 4-20 |
| Si | 0-1.57 |
| Co | Balance; |

wherein the total concentration of boron and carbon is between about 1.2 wt % and about 2.5 wt %;
wherein the Si has a concentration no greater than about (1.8−(0.12*[Mo])+(0.1*([B]+[C]))).

17. The method of claim 16 wherein the filler metal is in the form of a tubular wire comprising a Co-based sheath and metal powder placed therein.

18. The method of claim 16 wherein the filler metal consists essentially of, by approximate weight %:

| | |
|---|---|
| C | 0.3-2.4 |
| B | 0.1-1.0 |
| Cr | 25-35 |
| Mo | 4-20 |
| Si | 0.1-1.57 |
| Mn + Ni + Fe | 0-10 |
| W | 1-4 |
| Co | Balance. |

19. The method of claim 16 wherein the Si has a concentration between about 0.1 wt % and about 1.4 wt %.

20. The method of claim 16, wherein the filler metal consists essentially of about 1.2 wt % C, about 0.5 wt % B, about 29 wt % Cr, about 1.3 wt % W, about 8.5 wt % Mo, from about 0 to about 10 wt % elements selected from the group consisting of Mn, Ni, and Fe, less than about 1.4 wt % Si, and the balance being Co.
